(19) United States
(12) Patent Application Publication
(10) Pub. No.: US 2008/0092451 A1
(43) Pub. Date: Apr. 24, 2008

(54) Security device for a window

(75) Inventors: Joseph Famulare, Richmond Hill, NY (US); Eugene Orange, Richmond Hill, NY (US); Angelo Alfieri, Richmond Hill, NY (US)

Correspondence Address: COLLARD & ROE, P.C., 1077 NORTHERN BOULEVARD, ROSLYN, NY, 11576, US

(73) Assignee: ULTRA SASH WINDOW FACTORY, INC.

(21) Appl. No.: 11/580,099

(22) Filed: Oct. 12, 2006

(51) Int. Cl. E05B 55/00

(52) U.S. Cl. 49/449

(57) ABSTRACT

A security device for installation in an upper sash of a double-hung window, in which the window has a window frame having two side surfaces, a top surface and a bottom surface, a lower sash mounted in a lower half of the window frame and an upper sash mounted in an upper half of the window frame. The upper and lower sashes are mounted offset from each other so that they slide up and down the window frame independently of each other. The security device is mounted to the upper sash via a bracket, and comprises a post having a top end that abuts the top surface of the window frame and a bottom end abutting a top surface of the lower sash to prevent the lower sash from sliding within the window frame. There is a cross-bar running through the post perpendicular to a longitudinal axis of the post and extending in opposite directions from the post. The cross-bar is located immediately beneath the bracket to act as a stop against downward sliding of the upper sash.

### BACKGROUND OF THE INVENTION

1. Field of the Invention

This invention relates to a security device for a window. In particular, the invention relates to a device that is mounted on the upper sash of a double-hung window, and which prevents the window from being raised or lowered from the outside, or by a small child.

2. The Prior Art

Double-hung windows have an upper sash, which opens by sliding down, and a lower sash, which opens by sliding up. Most double-hung windows are provided with locks, which lock both sashes together to prevent opening of either sash. However, these locks are too easily opened, either by intruders or by small children.

### SUMMARY OF THE INVENTION

It is therefore an object of the invention to provide a security device for a double-hung window, which prevents intruders from opening either sash, prevents young children from opening the window, and yet is simple for an adult inside the home to remove for opening.

It is another object of the invention to provide a security device that can be configured to allow the window to open partially, to allow for air flow without compromising the security of the premises.

These and other objects are accomplished by a security device for installation in an upper sash of a double-hung window, in which the window has a window frame having two side surfaces, a top surface and a bottom surface, a lower sash mounted in a lower half of the window frame and an upper sash mounted in an upper half of the window frame. The upper and lower sashes are mounted offset from each other so that they slide up and down the window frame independently of each other. The security device is mounted to the upper sash via a bracket, and comprises a post having a top end that abuts the top surface of the window frame and a bottom end abutting a top surface of the lower sash to prevent the lower sash from sliding within the window frame. There is a cross-bar running through the post perpendicular to a longitudinal axis of the post and extending in opposite directions from the post. The cross-bar is located immediately beneath the bracket to act as a stop against downward sliding of the upper sash.

There may be a holding cup mounted on the top surface of the lower sash for receiving and holding the bottom end of the post in place on the window.

In another embodiment, the post is at least two inches shorter than a height of the upper sash, so that the upper or lower sash can be raised several inches when the post is installed.

The bracket is mounted to the upper sash approximately 3 inches below the top of the upper sash.

In one embodiment, the bracket has flexible arms that hold the post so that the post is removable from the bracket by pulling the post away from the bracket.

The security device has the advantage that it is simple to install in any double-hung window and can be removed at any time when the homeowner wants to open the window fully. The security device cannot be removed or disabled from the outside without breaking the window, and thus provides a reliable deterrent to burglars. In addition, the security device is difficult for young children to remove, and thus prevents a child from inadvertently falling out of an open window.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a typical double-hung window with one embodiment of the device according to the invention mounted in the upper sash;

FIG. 2 shows a close-up view of the device shown in FIG. 1;

FIG. 3 shows a cross-section of the device of FIGS. 1 and 2; and

FIG. 4 shows an alternative embodiment of the device mounted in a double-hung window, with the lower sash raised slightly.

### DETAILED DESCRIPTION OF THE PREFERRED EMBODIMENT

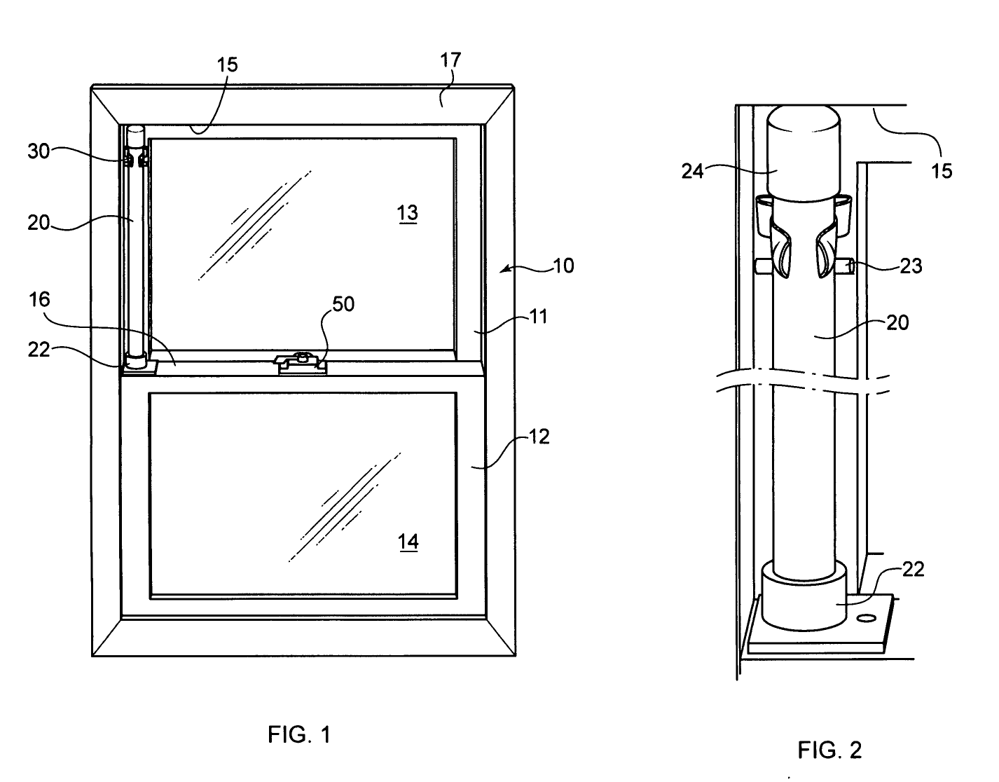

Referring now in detail to the drawings, FIGS. 1-3 show a first embodiment of the invention, which comprises a post 20 mounted in a double hung window 10. Window 10 has a window frame 17, an upper sash 11 slidably mounted in frame 17 and a lower sash 12 slidably mounted in frame 17. Upper sash 11 and lower sash 12 are disposed offset from each other, i.e., lower sash 12 is mounted more forward than upper sash 11, so that both sashes can slide within window frame 17 independently of each other. Each sash 11, 12 has a glass pane 13, 14, respectively, mounted therein. A lock 50 connects upper sash 11 to lower sash 12 to prevent sliding of either sash. However, lock 50 can be easily broken or circumvented by a prowler, so the device according to the invention can be used to prevent burglaries and to keep young children from opening the window.

One embodiment of the device according to the invention comprises a post 20 that is mounted in a holding cup 22, which is mounted on an upper surface 16 of lower sash 12. Post 20 is held in place on upper sash 11 by a bracket 30. A cross-bar 23 extends through the center of post 20 and is mounted immediately below bracket 30. When mounted in place, post 20 abuts a top 15 of window frame 17. As shown in the cross-sectional view of FIG. 3, bracket 30 is mounted to upper sash 11 by screws 33. Bracket 30 has two flexible arms 31, 32, that allow post 20 to be releasably snapped in place. To remove post 20, the user simply pulls post 20 away from sash 11 and snaps it out of bracket 30.

In use, post 20 prevents both the upper and lower sashes from sliding within window frame 17. The height of post 20, which matches the height of upper sash 11, causes post 20 to abut both the window frame and lower sash and prevents lower sash 12 from being raised. Cross-bar 23, which extends outwards beyond bracket 30, prevents upper sash 11 from being lowered, because the bracket abuts cross-bar 23 when an attempt is made to lower upper sash 11. Thus, post 20 reliably prevents movement of either sash in the window, yet can be easily removed by an adult on the inside of the window when needed.

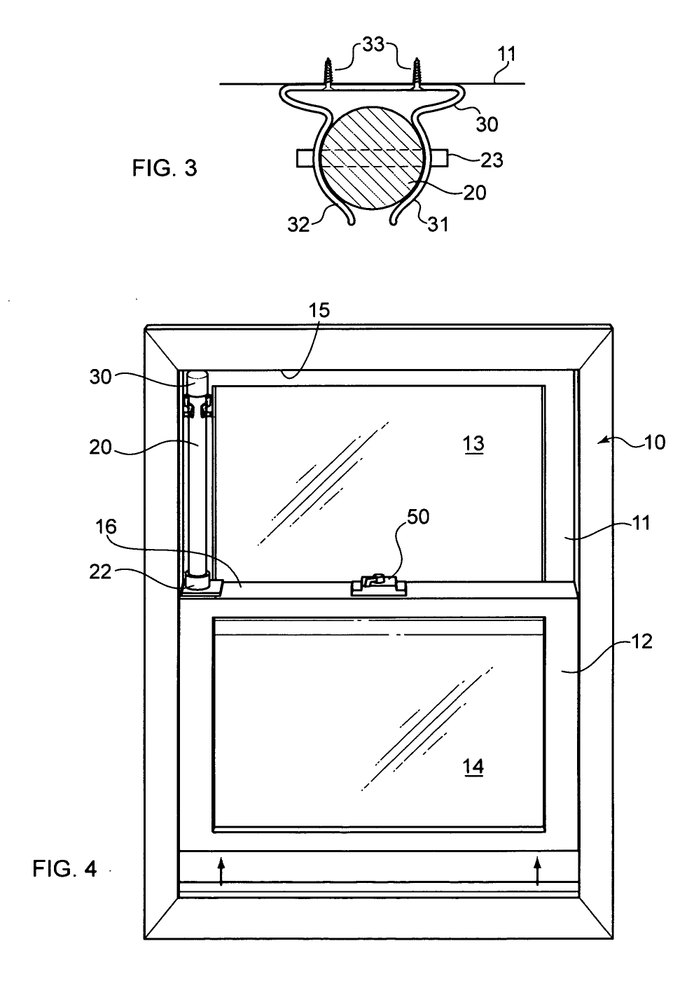

An alternative embodiment is shown in FIG. 4. In this embodiment, post 20 is made so that it is several inches shorter than the height of upper sash 11. This way, when post 20 is mounted to upper sash 11 so that the top of post 11 abuts surface 15, lower sash 12 can be raised several inches, until surface 16 abuts the lower end of sash 20. This way, the window can be opened enough to let in fresh air, yet remains secure against intruders, and safe for young children

Accordingly, while only a few embodiments of the present invention have been shown and described, it is obvious that many changes and modifications may be made thereunto without departing from the spirit and scope of the invention.

What is claimed is:

1. A security device for installation in a double-hung window having a window frame, a lower sash and an upper sash offset from the lower sash, the device comprising:
a post having a top end and a bottom end;
a cross-bar running through the post perpendicular to a longitudinal axis of the post and extending in opposite directions from the post; and
a bracket for mounting the post on a side of the upper sash, wherein said post prevents both the upper sash and the lower sash from being moved when said post is mounted to the upper sash with the bracket so that the post extends from a bottom of the upper sash to a top of the upper sash and the cross-bar is disposed adjacent the bracket.

2. The device according to claim 1, further comprising a holding cup for installation on an upper surface of the lower sash, said holding cup adapted to receive an end of the post to hold the post in place adjacent the upper sash.

3. A window assembly with a security device, comprising:
a window frame having two side surfaces, a top surface and a bottom surface;
a lower sash mounted in a lower half of the window frame;
an upper sash mounted in an upper half of the window frame and offset from said lower sash, wherein said upper and lower sashes are mounted to slide up and down the window frame independently of each other;
a security device mounted to the upper sash via a bracket, said security device comprising:
(a) a post having a top end and a bottom end, said top end abutting the top surface of the window frame and said bottom end adjacent a top surface of said lower sash to prevent the lower sash from sliding within the window frame beyond the bottom end of the post; and
(b) a cross-bar running through the post perpendicular to a longitudinal axis of the post and extending in opposite directions from the post, said cross-bar being located beneath the bracket to act as a stop against downward sliding of the upper sash.

4. The assembly according to claim 3, further comprising holding cups mounted on the top surface of the window frame and the top surface of the lower sash, said holding cups receiving and holding the ends of the post in place on the window.

5. The assembly according to claim 3, wherein the post is at least two inches shorter than a height of the upper sash, so that the upper or lower sash can be raised several inches when the post is installed.

6. The assembly according to claim 3, wherein the bottom end of the post abuts the top surface of the lower sash to keep the lower sash fully lowered and to prevent any sliding of the lower sash within the window frame.

7. The assembly according to claim 3, wherein the bracket is mounted to the upper sash approximately 3 inches below the top of the upper sash.

8. The assembly according to claim 3, wherein the bracket has flexible arms that hold the post and wherein the post is removable from the bracket by pulling the post away from the bracket.

9. A method for securing a double-hung window having a window frame and an upper sash and a lower sash slidably mounted in said window frame such that said upper and lower sashes are mounted offset from one another so that they slide independently of one another within said sash, the method comprising the following steps;
mounting a bracket on a side of the upper sash, said bracket being adapted to hold a post; and
mounting a post to the bracket;
wherein the post has a cross-bar that extends perpendicular to the post, the cross-bar being disposed immediately below the bracket, and wherein the post prevents the lower sash from being raised beyond a level where the post abuts the top surface of the lower sash and an underside of the window frame, and wherein the cross-bar prevents the upper sash from being lowered by preventing the bracket from sliding along the post below the cross-bar.

10. The method according to claim 9, wherein the post has a length such that the post extends from the top of the upper sash to the bottom of the upper sash and abuts a top surface of the lower sash.

11. The method according to claim 9, wherein the post is at least two inches shorter than a height of the upper sash.
